(19) United States
(12) Patent Application Publication
(10) Pub. No.: US 2025/0336035 A1
(43) Pub. Date: Oct. 30, 2025

(54) UPSCALING AI-GENERATED DIGITAL CONTENT WITHIN DIGITAL IMAGES VIA TILE-BASED SUPER RESOLUTION

(71) Applicant: Adobe Inc., San Jose, CA (US)

(72) Inventors: Connelly Barnes, Seattle, WA (US); Zhe Lin, Fremont, CA (US); Xiaoyang Liu, Bellevue, WA (US); Sohrab Amirghodsi, Seattle, WA (US); Qing Liu, Santa Clara, CA (US)

(21) Appl. No.: 18/646,543

(22) Filed: Apr. 25, 2024

(51) Int. Cl. G06T 3/4053; G06T 3/4046

(52) U.S. Cl. CPC G06T 3/4053; G06T 3/4046

(57) ABSTRACT

The present disclosure relates to systems, methods, and non-transitory computer-readable media that upscale AI-generated digital content via tile-based super resolution. For instance, in one or more embodiments, the disclosed systems determine a first set of tiles from a digital image having a set of pixels to be replaced with a generated content portion. The disclosed systems further determine a second set of tiles from a first modified digital image that corresponds to the digital image and includes the generated content portion at a first resolution. Based on the first set of tiles and the second set of tiles, the disclosed systems use a super resolution neural network to generate a second modified digital image that corresponds to the digital image and includes the generated content portion at a second resolution that is higher than the first resolution.

### BACKGROUND

Recent years have seen significant advancement in hardware and software platforms for editing digital images. Indeed, as the use of digital images has become increasingly ubiquitous, systems have developed to facilitate the manipulation of the content within such digital images. To illustrate, some systems leverage artificial intelligence to generate content within a digital image, such as through inpainting, outpainting, or generating entirely new objects or scenery for portrayal within the digital image.

### SUMMARY

One or more embodiments described herein provide benefits and/or solve one or more problems in the art with systems, methods, and non-transitory computer-readable media that implement tile-based super resolution via a neural network to upscale digital content generated for a digital image. For example, in one or more embodiments, a system breaks the neural network inputs into various tile sets. In some embodiments, the neural network inputs include the original digital image and a modified version of the digital image having digital content generated by a generative model (e.g., a diffusion neural network or a generative adversarial network). In some cases, the digital content produced by the generative model has a low resolution (e.g., lower than the original digital image). In some instances, the system uses the neural network to generate an output tile set based on the input tile sets. The system further assembles the output tiles using one or more blending techniques to generate a super-resolved image where the digital content from the generative model has a higher resolution (e.g., the same resolution as the original digital image). In this manner, the system efficiently implements a super resolution approach that can be flexibly deployed on various computing environments to provide high quality image results.

Additional features and advantages of one or more embodiments of the present disclosure are outlined in the description which follows, and in part will be obvious from the description, or are learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a tile-based super resolution system operates in accordance with one or more embodiments;

FIG. 2 illustrates the tile-based super resolution system generating a super-resolved digital image in accordance with one or more embodiments;

FIGS. 3A-3C illustrate the tile-based super resolution system generating a modified digital image having a generated content portion in response to user input received from a client device in accordance with one or more embodiments;

FIG. 4 illustrates the tile-based super resolution system generating a modified digital image having a generated content portion using an AI-based model in accordance with one or more embodiments;

FIG. 5 illustrates tile-based super resolution system upscaling the generated content portion of a modified digital image in accordance with one or more embodiments;

FIG. 6 illustrates the tile-based super resolution system implementing a tile-based approach to upscaling a generated content portion in accordance with one or more embodiments;

FIGS. 7A-7C illustrate the tile-based super resolution system using overlapping tiles in implementing a tile-based approach to upscaling a generated content portion for a digital image in accordance with one or more embodiments;

FIG. 8 illustrates an example schematic diagram of a tile-based super resolution system in accordance with one or more embodiments;

FIG. 9 illustrates a flowchart of a series of acts for upscaling a generated content portion incorporated into a digital image in accordance with one or more embodiments; and

FIG. 10 illustrates a block diagram of an exemplary computing device in accordance with one or more embodiments.

### DETAILED DESCRIPTION

One or more embodiments described herein include a tile-based super resolution system that employs a tile-based, neural network approach to upscaling digital content generated by artificial intelligence (AI) models for high-resolution image results. For instance, in some embodiments, the tile-based super resolution system uses a neural network (e.g., a cascaded modulation generative adversarial network) to process tile sets determined from a digital image and a modified version of the digital image. In some cases, the modified version includes AI-generated digital content having a low resolution (e.g., lower than the original digital image). In some instances, the neural network generates output tiles, and the tile-based super resolution system assembles the output tiles via one or more blending techniques to generate an image result. In some implementations, the image result includes the same AI-generated digital content but upscaled to a higher resolution (e.g., the resolution of the original digital image). Thus, in some cases, the tile-based super resolution system receives a digital image from a client device and provides a modified version of the digital image with high-resolution AI-generated content in response.

To illustrate, in one or more embodiments, the tile-based super resolution system receives, from a client device, a digital image having a set of pixels to be replaced with a generated content portion. Additionally, the tile-based super resolution system determines a first set of tiles from the digital image and determines a second set of tiles from a first modified digital image that corresponds to the digital image and includes the generated content portion at a first resolution. The tile-based super resolution system further generates, using a super resolution neural network and based on the first set of tiles and the second set of tiles, a second modified digital image that corresponds to the digital image and includes the generated content portion at a second resolution that is higher than the first resolution. The tile-based super resolution system also provides a super-resolved digital image generated from the second modified digital image for display on the client device.

As just indicated, in one or more embodiments, the tile-based super resolution system generates a super-resolved digital image that includes a generated content portion (e.g., generated from an AI model) having a high-resolution. In some embodiments, the tile-based super resolution system generates the super-resolved digital image by processing a digital image and a modified version of the digital image that includes the generated content portion. In certain embodiments, the generated content portion has a low resolution, such as a resolution that is lower than the resolution of the digital image. In some instances, the tile-based super resolution system further generates the super-resolved digital image by processing a mask for the digital image.

In some cases, the tile-based super resolution system generates the modified version of the digital image. For instance, in some cases, the tile-based super resolution system uses an AI-based generative model, such as a diffusion neural network or a cascaded modulation generative adversarial network, to generate the generated content portion. Thus, in some implementations, the tile-based super resolution system implements a pipeline by receiving a digital image, modifying the digital image to include a generated content portion, and upscaling the generated content portion for a super-resolved digital image output.

As further mentioned, in one or more embodiments, the tile-based super resolution system implements a tile-based approach to generating the super-resolved digital image. For instance, in some embodiments, the tile-based super resolution system determines a set of tiles for the digital image, the modified version of the digital image, and/or the mask to be processed. In some implementations, each set of tiles include overlapping tiles. Further, in some instance, each tile in a tile set is positioned completely within the boundaries of the corresponding image so that each tile includes valid image pixels and avoids padding.

Additionally, in some cases, the tile-based super resolution system generates an output tile set from the tile set(s) determined from the digital image, the modified digital image, and/or the mask. In some implementations, the output tile set portrays the generated content portion at a resolution that is higher than the resolution with which the generated content portion was initially created. In some instances, the output tile set also includes overlapping tiles. Thus, in certain embodiments, the tile-based super resolution system generates the super-resolved digital image by assembling the tiles using one or more blending techniques, such as linear blending and/or bilinear blending. In one or more embodiments, the tile-based super resolution system further composites the assembled tiles with the original digital image to produce the super-resolved digital image.

As also mentioned above, in one or more embodiments, the tile-based super resolution system uses a neural network to implement the tile-based approach. In particular, in some embodiments, the tile-based super resolution system uses a super resolution neural network to process the input tile set(s) and generate the output tile set. For example, in some cases, the tile-based super resolution system employs a cascaded modulation generative adversarial network.

In certain implementations, the tile-based super resolution system employs the super resolution neural network as one of multiple super resolution techniques. Indeed, in some embodiments, the tile-based super resolution system uses resampling in addition to, or as an alternative to, using the super resolution neural network. For example, in some cases, the tile-based super resolution system uses one or more thresholds to determine whether to use resampling, the super resolution neural network, or both.

The tile-based super resolution system provides advantages over conventional systems. Indeed, conventional systems for upscaling AI-generated digital content often suffer from several technological shortcomings that result in inefficient, inflexible, and inaccurate operation. To provide context around at least some implementations of the tile-based super resolution system, there are existing platforms that leverage AI-based models to generate digital content for digital images. In some cases, these platforms replace existing pixels within a digital image with AI-generated digital content, such as by removing an object and filling in the background or by adding entirely new objects or scenery for portrayal within the digital image. In other cases, these platforms add new portions to the digital image, such as through outpainting. The AI-based models, however, often produce generated content with limited resolution-typically well below the resolution of the rest of the digital image. Thus, some existing platforms incorporate or rely on systems that upscale the AI-generated digital content to a higher resolution.

Conventional systems for upscaling AI-generated digital content, however, are often inefficient in that they employ models that upscale the digital content by processing the entire image in a single pass. Such models typically require a significant amount of memory to operate, and the required amount often scales with the resolution of the image being processed. Thus, these systems are often computationally demanding when upscaling digital content to obtain a much higher resolution than initially produced.

Additionally, conventional systems are often inflexible. For instance, as many conventional systems employ models with high memory requirements, these systems are often impractical for deployment on the client device of the user editing the image. Indeed, deployment of these systems is typically limited to remote, cloud-based devices that can be accessed by client devices. In addition to maintenance costs, such a cloud-based deployment tends to increase the latency between user interactions and visible results or, at least, provides a latency that is reliant on the network connection of the client device.

Further, conventional systems often experience problems with accuracy. Indeed, while many conventional systems achieve AI-generated digital content with a higher resolution than initially produced, the results are often still lower in resolution than the rest of the digital image. Thus, image results generated by such systems are often poor in quality, having an unnatural appearance.

One or more embodiments of the tile-based super resolution system operate with improved efficiency when compared to conventional systems. For example, by implementing a tile-based approach, the tile-based super resolution system decreases the amount of memory required to upscale AI-generated digital content when compared to many conventional systems. For instance, in some implementations—such as when operating on a batch size of one—the tile-based super resolution system requires as little memory as the underlying model (e.g., the super resolution neural network). In some cases, the tile-based super resolution system scales the memory used to operate based on the memory budget of the environment in which it operates. Thus, in some instances, where a higher peak memory usage is available, the tile-based super resolution system processes larger batches during inference.

Additionally, one or more embodiments of the tile-based super resolution system operate with improved flexibility when compared to conventional systems. For example, by using a tile-based approach that decreases the amount of memory required to upscale AI-generated digital content, embodiments of the tile-based super resolution system are more flexibly deployable on the client devices of users editing digital images. Further, by offering scalable operations, the tile-based super resolution system is flexibly deployable in environments having a range of different memory budgets.

Further, one or more embodiments of the tile-based super resolution system operate with improved accuracy when compared to conventional systems. For example, by implementing a tile-based approach to upscaling AI-generated digital content, the tile-based super resolution system produces higher-resolution AI-generated digital content when compared to many conventional systems. Indeed, in some instances, the tile-based approach results in AI-generated digital content at the same resolution as the rest of the digital image. Thus, the tile-based super resolution system produces digital images that are high in quality with AI-generated digital content having a natural appearance.

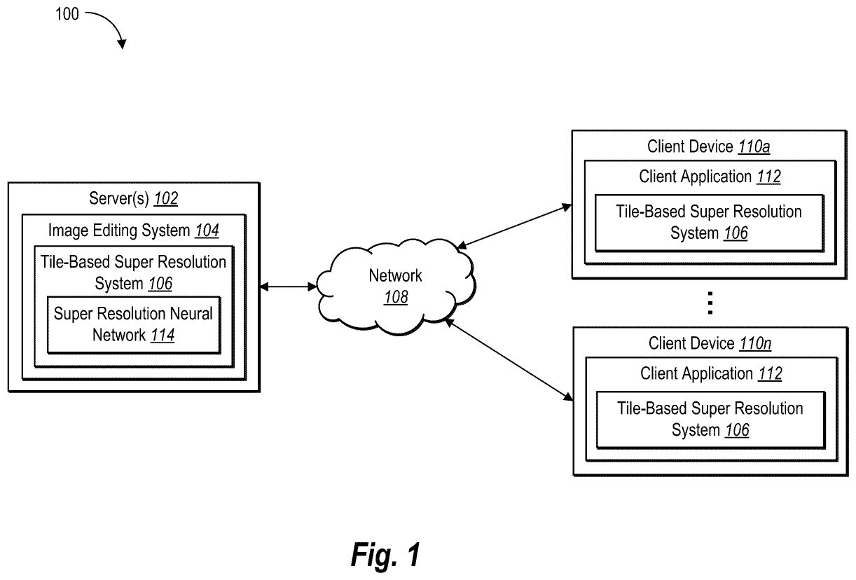

Additional detail regarding the tile-based super resolution system will now be provided with reference to the figures. For example, FIG. 1 illustrates a schematic diagram of an exemplary system 100 in which a tile-based super resolution system 106 operates. As illustrated in FIG. 1, the system 100 includes a server(s) 102, a network 108, and client devices 110a-110n.

Although the system 100 of FIG. 1 is depicted as having a particular number of components, the system 100 is capable of having any number of additional or alternative components (e.g., any number of servers, client devices, or other components in communication with the tile-based super resolution system 106 via the network 108). Similarly, although FIG. 1 illustrates a particular arrangement of the server(s) 102, the network 108, and the client devices 110a-110n, various additional arrangements are possible.

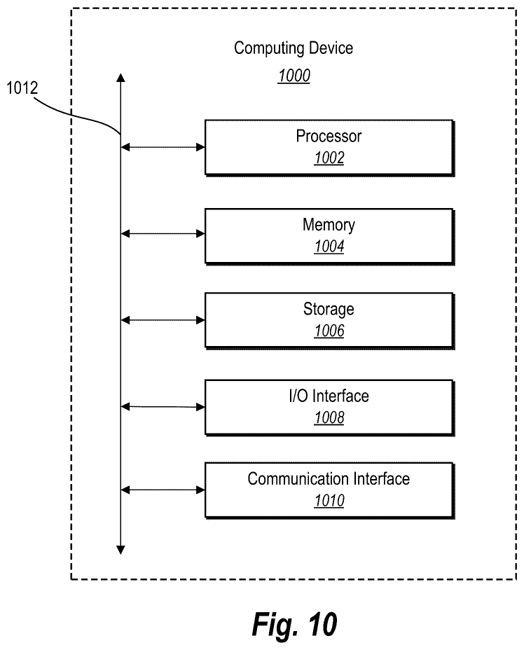

The server(s) 102, the network 108, and the client devices 110a-110n are communicatively coupled with each other either directly or indirectly (e.g., through the network 108 discussed in greater detail below in relation to FIG. 10). Moreover, the server(s) 102 and the client devices 110a-110n include one or more of a variety of computing devices (including one or more computing devices as discussed in greater detail with relation to FIG. 10).

As mentioned above, the system 100 includes the server(s) 102. In one or more embodiments, the server(s) 102 generates, stores, receives, and/or transmits data, including digital images, generated content portions, modified digital images having the generated content portions, and/or super-resolved digital images having the generated content portions. In one or more embodiments, the server(s) 102 comprises a data server. In some implementations, the server(s) 102 comprises a communication server or a web-hosting server.

In one or more embodiments, the image editing system 104 provides functionality by which a client device (e.g., a user of one of the client devices 110a-110n) generates, edits, manages, and/or stores digital images. For example, in some instances, a client device sends a digital image to the image editing system 104 hosted on the server(s) 102 via the network 108. The image editing system 104 then provides many options that are usable by the client device to edit the digital image, store the digital image, and subsequently search for, access, and view the digital image. For instance, in some cases, the image editing system 104 provides one or more options that are usable by the client device to modify a digital image with a generated content portion and/or upscale the resolution of the generated content portion.

In one or more embodiments, the client devices 110a-110n include computing devices that are capable of accessing, modifying, and/or storing digital images, including modified digital images and/or super-resolved digital images. For example, the client devices 110a-110n include one or more of smartphones, tablets, desktop computers, laptop computers, head-mounted-display devices, and/or other electronic devices. In some instances, the client devices 110a-110n include one or more applications (e.g., the client application 112) that are capable of accessing, modifying, and/or storing digital images, including modified digital images and/or super-resolved digital images. For example, in one or more embodiments, the client application 112 includes a software application installed on the client devices 110a-110n. Additionally, or alternatively, the client application 112 includes a web browser or other application that accesses a software application hosted on the server(s) 102 (and supported by the image editing system 104).

To provide an example implementation, in some embodiments, the tile-based super resolution system 106 on the server(s) 102 supports the tile-based super resolution system 106 on the client device 110n. For instance, in some cases, the tile-based super resolution system 106 on the server(s) 102 generates or learns parameters for the super resolution neural network 114. The tile-based super resolution system 106 then, via the server(s) 102, provides the super resolution neural network 114 to the client device 110n. In other words, the client device 110n obtains (e.g., downloads) the super resolution neural network 114 (e.g., with any learned parameters) from the server(s) 102. Once downloaded, the tile-based super resolution system 106 on the client device 110n utilizes the super resolution neural network 114 to generate super-resolved digital images independent from the server(s) 102.

In alternative implementations, the tile-based super resolution system 106 includes a web hosting application that allows the client device 110n to interact with content and services hosted on the server(s) 102. To illustrate, in one or more implementations, the client device 110n accesses a software application supported by the server(s) 102. The client device 110n provides input to the server(s) 102, such as a digital image having pixels to be replaced with a generated content portion. In response, the tile-based super resolution system 106 on the server(s) 102 generates a super-resolved digital image having the generated content portion. The server(s) 102 then provides the super-resolved digital image to the client device 110n for display.

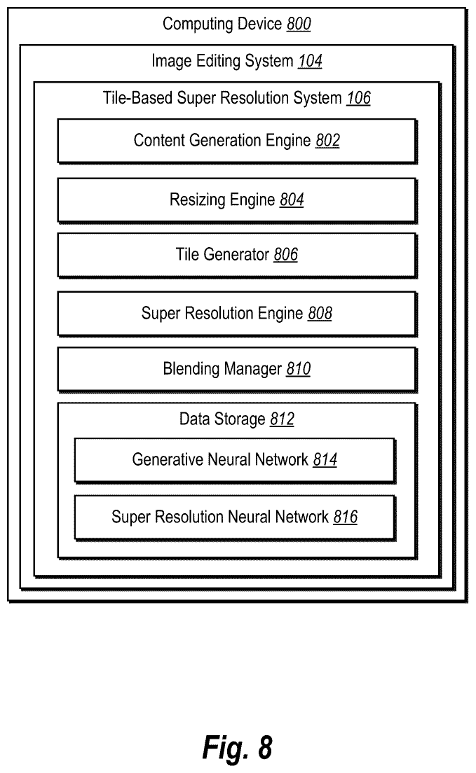

Indeed, the tile-based super resolution system 106 is able to be implemented in whole, or in part, by the individual elements of the system 100. Indeed, although FIG. 1 illustrates the tile-based super resolution system 106 implemented with regard to the server(s) 102, different components of the tile-based super resolution system 106 are able to be implemented by a variety of devices within the system 100. For example, one or more (or all) components of the tile-based super resolution system 106 are implemented by a different computing device (e.g., one of the client devices 110a-110n) or a separate server from the server(s) 102 hosting the image editing system 104. Indeed, as shown in FIG. 1, the client devices 110a-110n include the tile-based super resolution system 106. Example components of the tile-based super resolution system 106 will be described below with regard to FIG. 8.

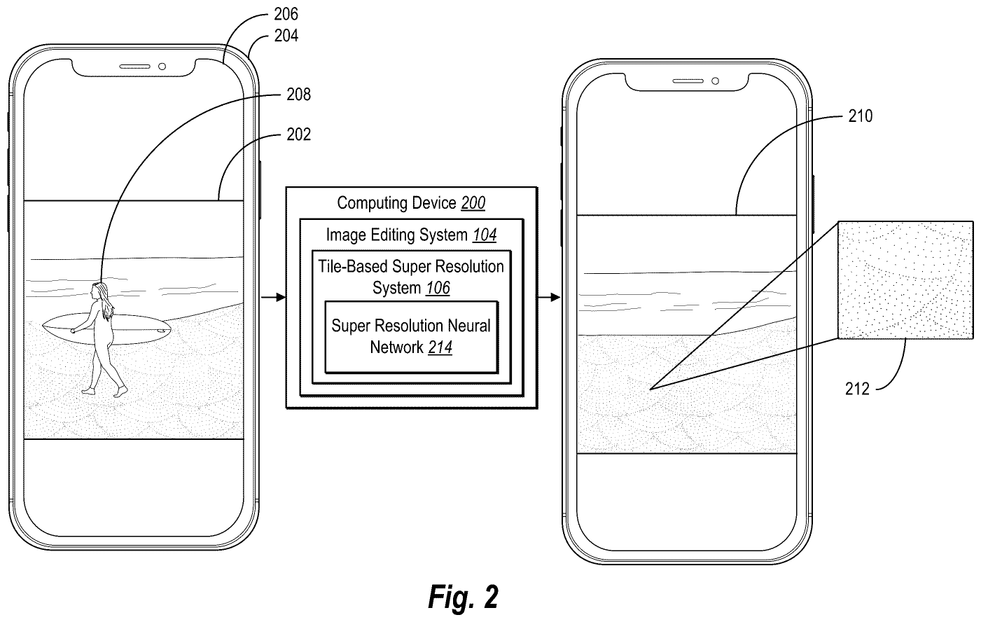

As mentioned, in one or more embodiments, the tile-based super resolution system 106 generates a super-resolved digital image from a digital image. In particular, the tile-based super resolution system 106 generates a super-resolved digital image having a generated content portion that replaces a set of pixels within the digital image. FIG. 2 illustrates the tile-based super resolution system 106 generating a super-resolved digital image in accordance with one or more embodiments.

In one or more embodiments, a generated content portion includes digital content that has been generated for inclusion within a digital image. For instance, in some embodiments, a generated content portion includes digital content that was not initially part of a digital image (e.g., not included within the digital image when the digital image was initially captured or created) but has been subsequently generated for inclusion within the digital image. To illustrate, in some instances, a generated content portion includes an object, a portion of an object, a scenery, or a portion of scenery generated for inclusion within a digital image. In some implementations, a generated content portion includes digital content generated by an AI-based model (e.g., a generative neural network), as will be discussed more below. Further, in some cases, a generated content portion includes digital content generated to replace a set of pixels within a digital image. In some instances, however, a generated content portion includes digital content that adds to the digital image beyond the initial boundaries of the digital image.

In one or more embodiments, a super-resolved digital image includes a digital image (e.g., a modified digital image) having one or more generated content portions that have been upscaled to a higher resolution. In particular, in some embodiments, a super-resolved digital image corresponds to another digital image but includes one or more generated content portions that have been upscaled to a resolution above the resolution with which the one or more generated content portions were originally generated. Indeed, in some implementations, a generated content portion has a low resolution when initially generated, such as a resolution that is significantly lower than the digital image within which the generated content portion is included. Thus, the tile-based super resolution system 106 generates a super-resolved digital image by upscaling the generated content portion. In some implementations, the generated content portion of a super-resolved digital image has a resolution that is equal to the resolution of the digital image within which the generated content portion is included. In some instances, a super-resolved digital image includes an upscaled image result of one or more super resolution techniques implemented by the tile-based super resolution system 106. For instance, as will be shown below, in some cases, a super-resolved digital image includes an upscaled image result generated using a super resolution neural network and/or resampling.

As shown in FIG. 2, the tile-based super resolution system 106 (operating on a computing device 200) receives a digital image 202 from a client device 204. In some cases, the tile-based super resolution system 106 further receives, via a graphical user interface 206 of the client device 204, user input for modifying the digital image 202. For example, in some instances, the tile-based super resolution system 106 receives user input for removing an object 208 portrayed within the digital image 202. In some cases, based on receiving the user input for removing the object 208, the tile-based super resolution system 106 determines to fill in a hole resulting from removal of the object 208 with a generated content portion. In some implementations, the tile-based super resolution system 106 receives explicit user input for filling in the hole with the generated content portion.

As further shown in FIG. 2, the tile-based super resolution system 106 generates a super-resolved digital image 210 from the digital image 202. As illustrated, the super-resolved digital image 210 is modified relative to the digital image 202 in that the object 208 has been removed. Further, the hole resulting from removal of the object 208 has been filled with a generated content portion 212. In other words, the object 208 has been replaced by the generated content portion 212 within the super-resolved digital image 210.

As further indicated in FIG. 2, the tile-based super resolution system 106 generates the super-resolved digital image 210 to include the generated content portion 212 with a resolution that matches the resolution of the rest of the image. Indeed, as will be described in more detail below, the tile-based super resolution system 106 upscales generated content portions to have a higher resolution than was initially provided. In some cases, the tile-based super resolution system 106 upscales a generated content portion to include a resolution that matches the resolution of the rest of the image. Thus, the tile-based super resolution system 106 outputs super-resolved digital images having high quality, high resolution digital content portions.

As illustrated, the tile-based super resolution system 106 uses a super resolution neural network 214 to generate the super-resolved digital image 210. In one or more embodiments, a neural network includes a type of machine learning model, which can be tuned (e.g., trained) based on inputs to approximate unknown functions used for generating the corresponding outputs. In particular, in some embodiments, a neural network includes a model of interconnected artificial neurons (e.g., organized in layers) that communicate and learn to approximate complex functions and generate outputs based on inputs provided to the model. In some instances, a neural network includes one or more machine learning algorithms. Further, in some cases, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a generative adversarial network, a graph neural network, a multi-layer perceptron, or a diffusion neural network. In some embodiments, a neural network includes a combination of neural networks or neural network components.

In one or more embodiments, a super resolution neural network includes a computer-implemented neural network used to generate super-resolved digital images. In particular, in some embodiments, a super resolution neural network includes a neural network that upscales a generated content portion incorporated within a digital image. As will be shown, in some embodiments, a super resolution neural network upscales a generated content portion based on processing one or more inputs, such as an initial digital image without the generated content portion, a modified digital image having the generated content portion, and a corresponding mask (e.g., a soft mask). In some implementations, a super resolution neural network processes tiles (e.g., overlapping tiles) generated from the inputs and generates output tiles having the upscaled generated content portion. Indeed, as will be shown, the tile-based super resolution system 106 uses the output of a super resolution neural network to generate a super-resolved digital image in some instances.

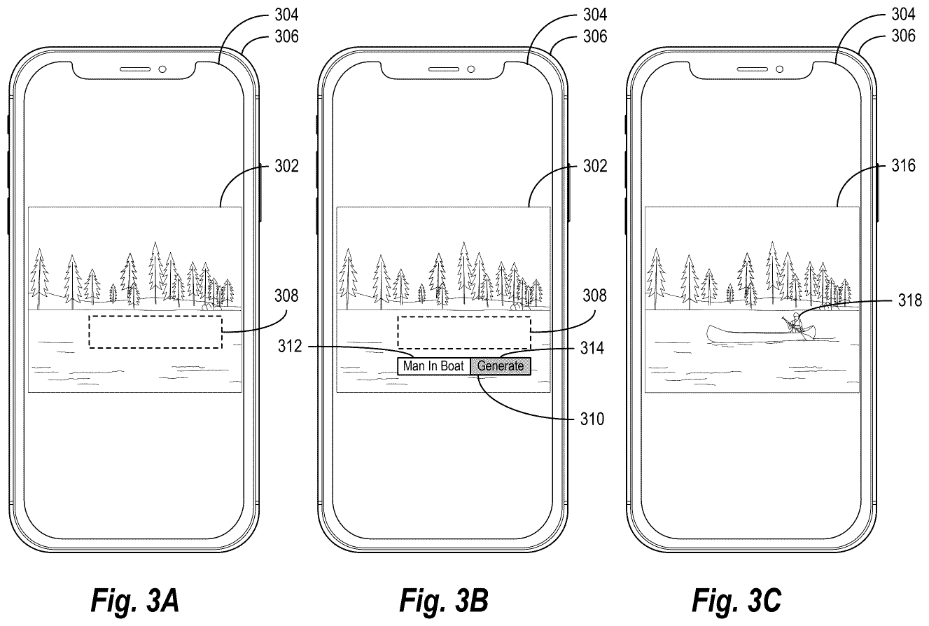

As just mentioned, in one or more embodiments, the tile-based super resolution system 106 generates a super-resolved digital image by upscaling a generated content portion incorporated within a digital image. In some cases, the tile-based super resolution system 106 receives a modified digital image having the generated content portion for use in generating the super-resolved digital image. In certain embodiments, however, the tile-based super resolution system 106 generates a modified digital image having the generated content portion and uses the modified digital image in generating the super-resolved digital image. FIGS. 3A-3C illustrate the tile-based super resolution system 106 generating a modified digital image having a generated content portion in accordance with one or more embodiments. In particular, FIGS. 3A-3C illustrate the tile-based super resolution system 106 generating a modified digital image having a generated content portion in response to user input received from a client device in accordance with one or more embodiments.

Indeed, as shown in FIG. 3A, the tile-based super resolution system 106 provides a digital image 302 for display within a graphical user interface 304 of a client device 306. As further shown, the tile-based super resolution system 106 provides a bounding box 308 for display, indicating a portion of the digital image 302 to be modified. In one or more embodiments, the tile-based super resolution system 106 generates and provides the bounding box 308 for display in response to one or more user interactions with the digital image 302 via the graphical user interface 304. For instance, in some cases, the tile-based super resolution system 106 generates and provides the bounding box 308 in response to one or more user interactions outlining or otherwise designating the portion of the digital image 302 to be modified.

As shown in FIG. 3B, the tile-based super resolution system 106 provides an interactive element 310 for display within the graphical user interface 304. In some cases, the tile-based super resolution system 106 provides the interactive element 310 for display in response to the user input designating the portion of the digital image 302 to be modified. Thus, in some instances, the tile-based super resolution system 106 provides the interactive element 310 in association with the bounding box 308.

As illustrated, the interactive element 310 includes a text box 312 for user input. Indeed, as indicated, the tile-based super resolution system 106 receives text input via the text box 312. In certain embodiments, the text input indicates a modification to be made to the portion of the digital image 302 indicated by the bounding box 308. For instance, as shown, the text input indicates a generated content portion (e.g., an object) to be added to the portion of the digital image 302.

The interactive element 310 also includes a selectable option 314 for modifying the digital image 302 in accordance with the text input received via the text box 312. For instance, as illustrated, the selectable option 314 includes a button for generating the generated content portion indicated by the received text input. Thus, in some cases, the tile-based super resolution system 106 generates a generated content portion for inclusion within the digital image 302 in response to detecting a selection of the selectable option 314. In particular, the tile-based super resolution system 106 generates a modified digital image having the generated content portion.

Indeed, as illustrated in FIG. 3C, the tile-based super resolution system 106 provides a modified digital image 316 for display within the graphical user interface 304 of the client device 306. As shown, the modified digital image 316 corresponds to the digital image 302 in that the modified digital image 316 portrays the same scene portrayed within the digital image 302. In other words, the modified digital image 316 is a modified version of the digital image 302. Indeed, while the present disclosure separately refers to a digital image and a modified digital image, it should be noted that a modified digital image includes a modified version of a digital image. In particular, in one or more embodiments, a modified digital image includes a digital image having one or more modifications applied thereto (e.g., a set of pixels replaced with a generated content portion or having one or more borders extended with the addition of a generated content portion). While, in some instances, a modified digital image includes a separate image file from the digital image used to generate the modified digital image, the modified digital image includes the same image file but modified based on changes to the digital image in other cases.

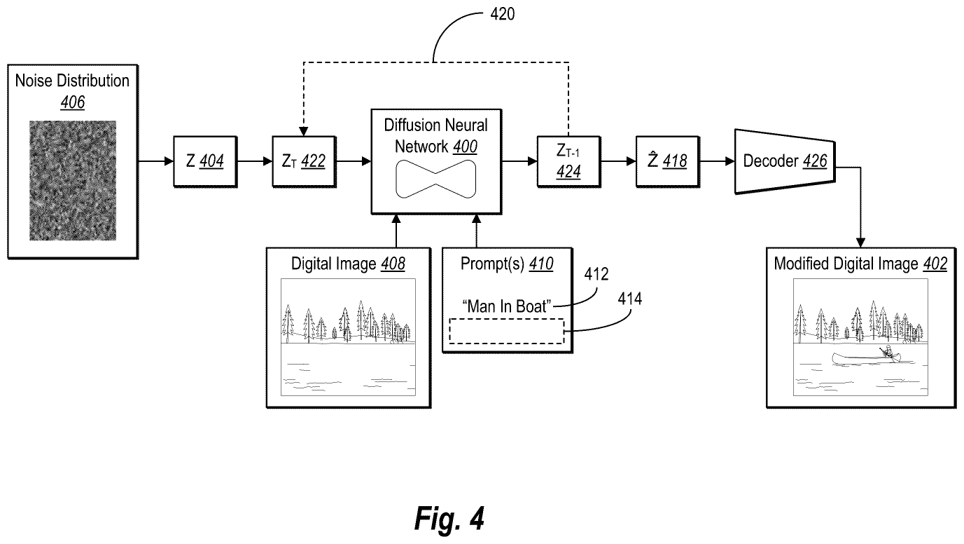

Indeed, as further shown, the modified digital image 316 includes a generated content portion 318 added to the portion of the digital image 302 indicated by the bounding box 308. Thus, in certain embodiments, the tile-based super resolution system 106 generates the modified digital image 316 from the digital image 302 by generating the generated content portion 318 and incorporating the generated content portion 318 within the digital image 302. In some implementations, the tile-based super resolution system 106 generates the modified digital image 316 as described below with reference to FIG. 4.

Notably, FIG. 2 illustrates the tile-based super resolution system 106 modifying a digital image by replacing an object portrayed therein with a generated content portion that fills in a resulting hole, while FIG. 3 illustrates the tile-based super resolution system 106 modifying a digital image by adding a new object positioned over existing content. More generally, in one or more embodiments, the tile-based super resolution system 106 modifies a digital image by replacing a set of pixels within the digital image with a generated content portion. To illustrate, in some cases, the tile-based super resolution system 106 receives user input identifying a set of pixels within a digital image (e.g., an object or a portion of the background) to be replaced with a generated content portion. In response to the user input, the tile-based super resolution system 106 generates the generated content portion. The tile-based super resolution system 106 further replaces the identified set of pixels with the generated content portion, such as by removing the set of pixels and filling in the resulting hole with the generated content portion (e.g., via inpainting) or by superimposing the generated content portion over the set of pixels.

Additionally, while the present disclosure largely discusses modifying a digital image by replacing pixels portrayed therein, the tile-based super resolution system 106 modifies a digital image by extending the digital image beyond its initial boundaries (e.g., via outpainting) in some cases. Indeed, in some implementations, the tile-based super resolution system 106 uses a generated content portion to add to the height and/or width of a digital image. Thus, in certain embodiments, rather than replacing pixels of a digital image with a generated content portion, the tile-based super resolution system 106 uses a generated content portion to portray portions of the scene of a digital image that were outside the boundaries when the digital image was initially captured or created (e.g., outside the boundaries of the camera used to capture the digital image or outside the boundaries of the canvas used to create the digital image).

As previously discussed, in one or more embodiments, the tile-based super resolution system 106 modifies a digital image by replacing a set of pixels portrayed therein with a generated content portion (or by extending the height and/or width of the digital image). In other words, the tile-based super resolution system 106 generates a modified digital image having the generated content portion in place of the set of pixels (or added to one or more ends of the digital image). As further discussed, in some implementations, the tile-based super resolution system 106 generates the modified digital image (e.g., generates the generated content portion) using an AI-based model. FIG. 4 illustrates the tile-based super resolution system 106 generating a modified digital image having a generated content portion using an AI-based model in accordance with one or more embodiments.

Indeed, FIG. 4 illustrates the tile-based super resolution system 106 using a generative neural network to generate a modified digital image having a generated content portion. In one or more embodiments, a generative neural network includes a computer-implemented neural network that generates digital content. In particular, in some embodiments, a generative neural network includes a neural network that generates digital visual content. For instance, in some cases, a generative neural network includes a neural network that generates generated content portions for inclusion within digital images. In some instances, a generative neural network includes a neural network that generates modified digital images having the generated content portions.

In particular, FIG. 4 illustrates the tile-based super resolution system 106 using a diffusion neural network 400 to generate a modified digital image 402 having a generated content portion in accordance with one or more embodiments. As shown in FIG. 4, the tile-based super resolution system 106 determines a noised latent tensor 404 (represented as z) from a noise distribution 406. For instance, in some implementations, the tile-based super resolution system 106 samples from the noise distribution 406 to determine the noised latent tensor 404. As shown, the tile-based super resolution system 106 provides the noised latent tensor 404 as input to the diffusion neural network 400.

As further illustrated, the tile-based super resolution system 106 also provides a digital image 408 and one or more prompts 410 as input to the diffusion neural network 400. In one or more embodiments, the digital image 408 includes the digital image to be modified with a generated content portion. Further, in some embodiments, the one or more prompts 410 include at least one of a text prompt 412 or a bounding box prompt 414, where the bounding box prompt 414 indicates the portion of the digital image 408 to be modified with the generated content portion (e.g., the set of pixels to be replaced with the generated content portion). In certain embodiments, the tile-based super resolution system 106 uses the digital image 408 and/or the one or more prompts 410 to as one or more conditions (e.g., a spatial condition and/or a global condition) to for the diffusion neural network 400.

As illustrated in FIG. 4, the tile-based super resolution system 106 uses the diffusion neural network 400 to generate a denoised latent tensor 418 (represented as 2) from the noised latent tensor 404. In particular, in some cases, the tile-based super resolution system 106 uses the diffusion neural network 400 to generate the denoised latent tensor 418 from the noised latent tensor 404 based on the one or more conditions represented by the digital image 408 and/or the one or more prompts 410.

As further illustrated, the tile-based super resolution system 106 uses the diffusion neural network 400 to generate the denoised latent tensor 418 from the noised latent tensor 404 via an iterative denoising process (indicated by the dashed arrow 420). Indeed, in some embodiments, the tile-based super resolution system 106 uses the diffusion neural network 400 to generates the denoised latent tensor 418 over a plurality of diffusion steps. Thus, as shown by FIG. 4, for a given diffusion step, the diffusion neural network 400 processes a first latent tensor 422 (represented as Z_{T}) to generate a second latent tensor 424 (represented as Z_{T-1}), where the transition from T to T−1 represents a transition as part of a backward diffusion process q (Zₜ₋₁|Zₜ). In some cases, while the first latent tensor 422 includes a noised latent tensor (as it has not completed the denoising process), the second latent tensor 424 represents a noised latent tensor (e.g., if the denoising process has not finished) or a denoised latent tensor (e.g., if the denoising process is complete).

To illustrate, in some instances, for a first diffusion step, the first latent tensor 422 includes the noised latent tensor 404. Additionally, in some cases, for a last diffusion step, the second latent tensor 424 includes the denoised latent tensor 418.

As further shown in FIG. 4, the tile-based super resolution system 106 uses a decoder 426 to generate the modified digital image 402 from the denoised latent tensor 418. For instance, in some cases, the latent tensors processed and output by the diffusion neural network 400 include data in latent space. Accordingly, the tile-based super resolution system 106 uses the decoder 426 to project the data of the denoised latent tensor 418 into pixel space in some implementations.

In one or more embodiments, the tile-based super resolution system 106 uses, as the diffusion neural network 400, the controlled diffusion neural network described in U.S. patent application Ser. No. 18/455,023 filed on Aug. 24, 2023, entitled GENERATING DIGITAL MATERIALS FROM DIGITAL IMAGES USING A CONTROLLED DIFFUSION NEURAL NETWORK, which is incorporated herein by reference in its entirety. In some cases, the tile-based super resolution system 106 further uses the decoders, style encoder, and/or conditioning network described in U.S. patent application Ser. No. 18/455,023.

Though FIG. 4 shows the tile-based super resolution system 106 using a diffusion neural network to generate a modified digital image having a generated content portion, the tile-based super resolution system 106 uses various generative neural networks in various implementations. For instance, in some cases, the tile-based super resolution system 106 uses a generative adversarial network to generate a modified digital image having a generated content portion. For example, in some embodiments, the tile-based super resolution system 106 uses a cascaded modulation generative adversarial neural network (e.g., the cascaded modulation inpainting neural network) described in U.S. patent application Ser. No. 17/661,985 filed on May 4, 2022, entitled DIGITAL IMAGE INPAINTING UTILIZING A CASCADED MODULATION INPAINTING NEURAL NETWORK or the cascaded modulated generative adversarial network described in U.S. patent application Ser. No. 18/232,212 filed on Aug. 9, 2023, entitled DEEP LEARNING-BASED HIGH RESOLUTION IMAGE INPAINTING, both of which are incorporated herein by reference in their entirety.

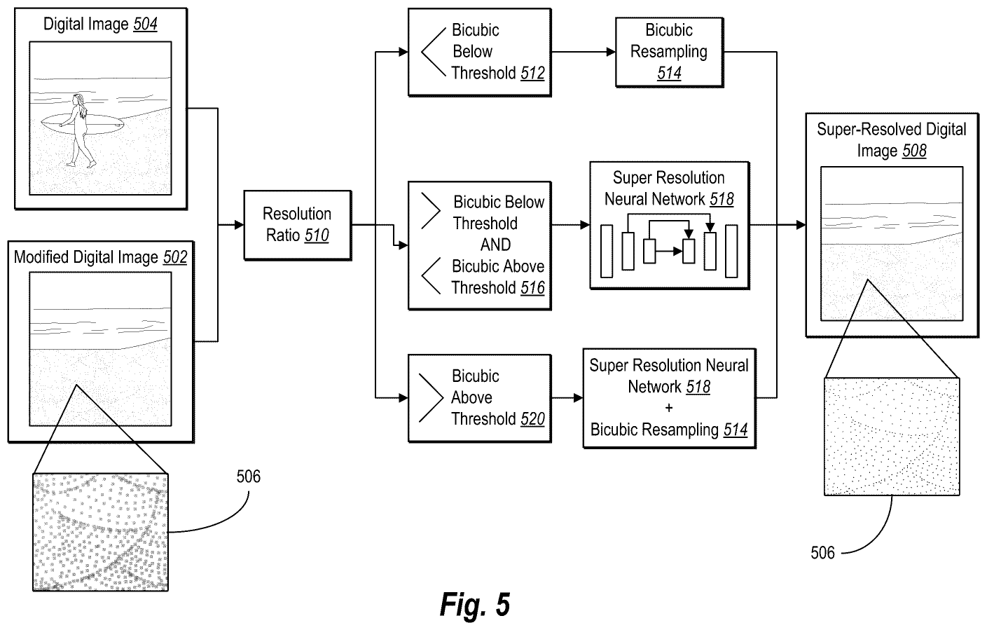

As previously mentioned, in one or more embodiments, the tile-based super resolution system 106 upscales the generated content portion of a modified digital image via one or more super resolution techniques. For instance, as previously discussed, the tile-based super resolution system 106 upscales the generated content portion of a modified digital image using a super resolution neural network and/or resampling in certain implementations. FIG. 5 illustrates tile-based super resolution system 106 upscaling the generated content portion of a modified digital image in accordance with one or more embodiments.

As shown in FIG. 5, the tile-based super resolution system 106 upscales the generated content portion of a modified digital image 502 generated from a digital image 504. In one or more embodiments, the tile-based super resolution system 106 generates the modified digital image 502 from the digital image 504 as discussed above with reference to FIGS. 3-4. As shown, the modified digital image 502 includes a generated content portion 506. The generated content portion 506, however, has a lower resolution than the rest of the modified digital image 502. Indeed, in certain implementations, the tile-based super resolution system 106 generates the generated content portion 506 at a first resolution that is lower than the digital image being modified (e.g., the digital image 504) via incorporation of the generated content portion 506. To illustrate, in some instances, the digital image 504 and the modified digital image 502 generally include the same resolution except for the generated content portion 506 of the modified digital image 502, which has a comparatively lower resolution.

As FIG. 5 further illustrates, the tile-based super resolution system 106 uses one or more super resolution techniques to upscale the generated content portion 506 and produce a super-resolved digital image 508. The super-resolved digital image 508 includes the generated content portion 506 but at a resolution that is higher than the first resolution with which the generated content portion 506 was originally created. In some instances, the resolution of the generated content portion 506 resulting from the one or more super resolution techniques is equal to the resolution of the digital image 504.

Indeed, in one or more embodiments, the resolution of the generated content portion 506 is higher within the super-resolved digital image 508 than in the digital image 504 as a result of the one or more super resolution techniques. In one or more embodiments, a higher resolution includes a resolution that is at least incrementally higher than another resolution (e.g., includes at least one more pixel than the other resolution). In some embodiments, however, a higher resolution includes a resolution that is higher than another resolution by at least a threshold amount. The threshold amount varies in various implementations. For instance, in some cases, a higher resolution includes a resolution that is at least five to ten percent higher than another resolution. In some embodiments, however, a higher resolution includes a resolution that is significantly higher than another resolution. For example, in some cases, a higher resolution includes a resolution that is between 1.10 to 3.00 times higher than another resolution. In some cases, a higher resolution includes a resolution that is more than 3.00 times higher than another resolution. While particular thresholds and upscaling factors are discussed herein, it should be understood that different implementations of the tile-based super resolution system 106 implement different thresholds and upscaling factors or implement upscaling factors based on the difference between the initial resolution a generated content portion and a target resolution (e.g., the resolution of the rest of the digital image). Thus, in some cases, the tile-based super resolution system 106 upscales a generated content portion to increase its resolution by several factors.

As shown in FIG. 5, the tile-based super resolution system 106 uses a resolution ratio 510 and various thresholds to determine which super resolution technique(s) to employ in producing the super-resolved digital image 508. In one or more embodiments, the tile-based super resolution system 106 determines the resolution ratio 510 based on the resolution of the digital image 504 to the first resolution of the generated content portion 506. For instance, in some cases, the tile-based super resolution system 106 determines the resolution ratio 510 to be the ratio of the resolution of the digital image 504 to the first resolution of the generated content portion 506.

In some cases, the tile-based super resolution system 106 uses the resolution ratio 510 as an indicator of the factor to upscale the generated content portion 506 (i.e., an upscaling factor). For instance, in some cases, when upscaling the generated content portion 506 to include a resolution that equals the resolution of the digital image 504, the tile-based super resolution system 106 upscales the generated content portion 506 by a factor equal to the upscaling factor indicated by the resolution ratio 510. Indeed, as mentioned, in some cases, the tile-based super resolution system 106 uses the resolution of the digital image 504 as the target resolution for upscaling the generated content portion 506 and further uses the resolution ratio 510 to indicate the upscaling factor needed to achieve the target resolution. While FIG. 5 shows the resolution of the digital image 504 as the target resolution, the tile-based super resolution system 106 uses a different resolution as the target in some implementations.

As further shown, in FIG. 5, the tile-based super resolution system 106 compares the resolution ratio 510 to a low threshold and/or a high threshold to determine which super resolution technique(s) to employ in upscaling the generated content portion 506. In one or more embodiments, each of the low threshold and the high threshold include a factor threshold or ratio threshold. In particular, in some embodiments, each of the low threshold and the high threshold include a numerical value that is comparable to resolution ratios. In some instances, as will be explained, the tile-based super resolution system 106 uses the low threshold and the high threshold to determine when to employ resampling as an alternative to, or in addition to, using a super resolution neural network.

In one or more embodiments, each of the low threshold and high threshold is a hyperparameter that is configurable via user input. In some instances, however, the tile-based super resolution system 106 establishes each of the low threshold and the high threshold based on determining values that provide the best results in terms of efficiency and high-resolution output.

As FIG. 5 illustrates, upon determining that the resolution ratio 510 falls below (or, in some instances, is at least equal to) the low threshold—as indicated by box 512—the tile-based super resolution system 106 upscales (e.g., up-samples) the generated content portion 506. Specifically, in one or more implementations, the tile-based super resolution system 106 upscales via bicubic resampling 514, a resampling filter, or a lightweight neural upsampler. More specifically, the tile-based super resolution system 106 upscales using a filter that changes the image sample rate using bicubic, bilinear, Lanczos, Gaussian filter, sinc filter, or other linear digital signal processing filter. In the case of a lightweight neural upsampler, the tile-based super resolution system 106 uses a neural super-resolution network such as CMGAN-SR but with layers pruned such that the execution is very fast.

As mentioned, in some embodiments, the tile-based super resolution system 106 uses the bicubic resampling 514 to upscale the generated content portion 506 by the upscaling factor indicated by the resolution ratio 510. As indicated by FIG. 5, in this scenario, the tile-based super resolution system 106 uses the bicubic resampling 514 as an alternative to using a super resolution neural network to perform the upscaling.

Indeed, in some cases, the bicubic resampling 514 provides a faster upscaling solution than a super resolution neural network but produces perceptually similar results for small amounts of upscaling. Thus, in certain implementations, where the amount of upscaling needed (as indicated by the resolution ratio 510) is small, the tile-based super resolution system 106 uses the bicubic resampling 514 to provide results efficiently. In some cases, the tile-based super resolution system 106 establishes a low low threshold (e.g., a value between 1.05 and 1.10) to enable the use of the bicubic resampling 514 for small amounts of upscaling but to prevent using the bicubic resampling 514 for larger amounts of upscaling. Indeed, in some cases, using bicubic resampling for larger amounts of upscaling produces results that are perceptually lower in quality. Thus, in some cases, the tile-based super resolution system uses the low threshold to prevent low-quality upscaling results.

Additionally, as shown in FIG. 5, upon determining that the resolution ratio 510 is above (or, in some instances, is at least equal to) the low threshold and below (or, in some instances, is at least equal to) the high threshold—as indicated by box 516—the tile-based super resolution system 106 upscales the generated content portion 506 using a super resolution neural network 518. In particular, in some embodiments, the tile-based super resolution system 106 uses the super resolution neural network 518 to upscale the generated content portion 506 by the upscaling factor indicated by the resolution ratio 510. As indicated by FIG. 5, in this scenario, the tile-based super resolution system 106 uses the super resolution neural network 518 as an alternative to using the bicubic resampling 514 to perform the upscaling.

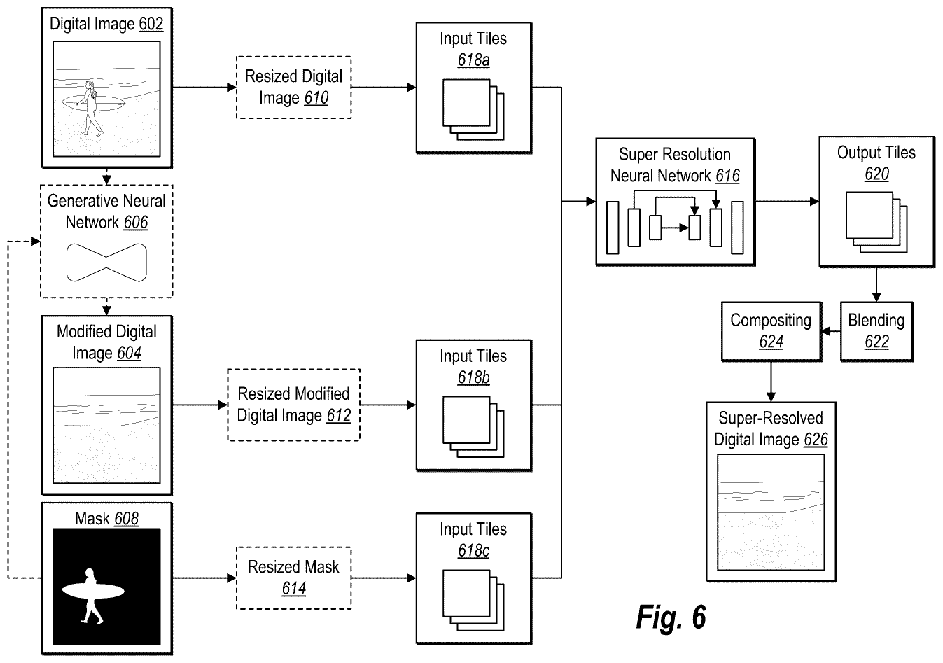

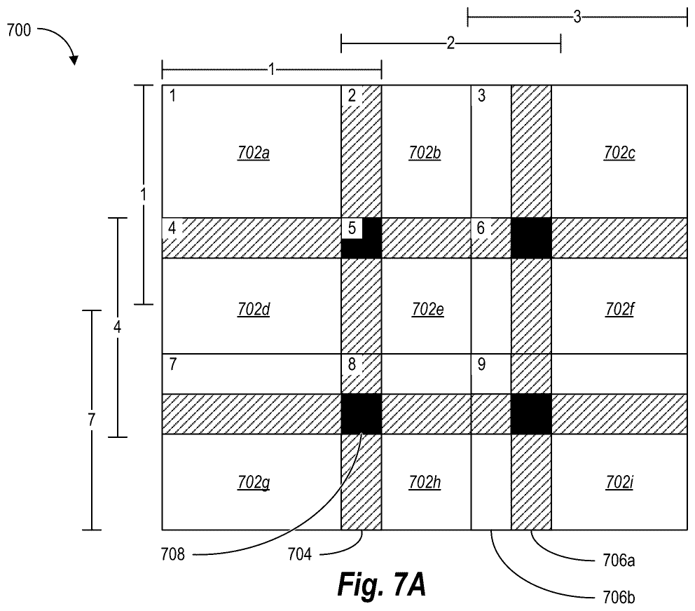

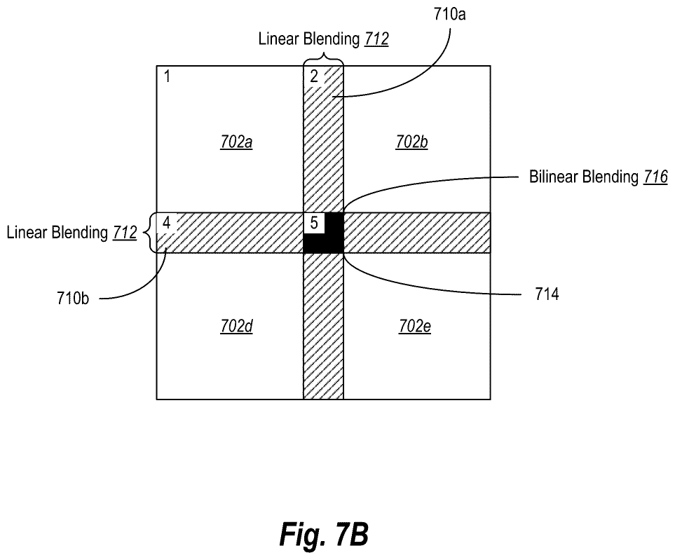

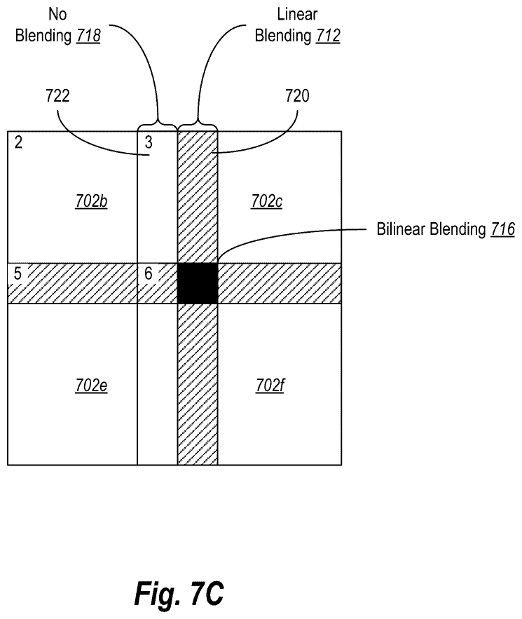

As will be discussed below with respect to FIGS. 6-7C, in some cases, the tile-based super resolution system 106 uses the super resolution neural network 518 to implement a tile-based approach to super resolution. Thus, in some instances, the tile-based super resolution system 106 uses the super resolution neural network 518 to produce tiles that include the upscaled version of the generated content portion 506. As will further be described, in some cases, the tile-based super resolution system 106 further processes the tiles to produce the super-resolved digital image 508.

In one or more embodiments, the tile-based super resolution system 106 establishes a relatively high high threshold (e.g., a value of 3.0) to enable use of the super resolution neural network 518 for large amounts of upscaling.

As further shown in FIG. 5, upon determining that the resolution ratio 510 is above (or, in some instances, is at least equal to) the high threshold—as indicated by box 520—the tile-based super resolution system 106 upscales the generated content portion 506 using the super resolution neural network 518 and the bicubic resampling 514. In particular, in some embodiments, the tile-based super resolution system 106 uses the combination of the super resolution neural network 518 and the bicubic resampling 514 to upscale the generated content portion 506 by the upscaling factor indicated by the resolution ratio 510. As indicated by FIG. 5, in this scenario, the tile-based super resolution system 106 uses the super resolution neural network 518 followed by the bicubic resampling 514 to perform the upscaling, though the tile-based super resolution system 106 uses the reverse order in some implementations.

To illustrate, in one or more embodiments, the tile-based super resolution system 106 uses the super resolution neural network 518 to implement the tile-based approach (described below with reference to FIGS. 6-7C) to upscaling the generated content portion 506. In particular, in some embodiments, the tile-based super resolution system 106 uses the super resolution neural network 518 to upscale the generated content portion 506 by a factor that is equal to the high threshold. Thus, by using the super resolution neural network 518, the tile-based super resolution system 106 produces a modified digital image having the generated content portion 506 at a resolution (e.g., a second resolution) that is higher than the first resolution with which the generated content portion 506 was originally created. The tile-based super resolution system 106 further uses the bicubic resampling 514 to upscale (e.g., up-sample) the modified digital image resulting from use of the super resolution neural network 518. In particular, the tile-based super resolution system 106 uses the bicubic resampling 514 to up-sample the modified digital image by upscaling the generated content portion 506 so that the final amount of upscaling is equal to the upscaling factor indicated by the resolution ratio 510. Thus, in some embodiments, via the bicubic resampling 514, the tile-based super resolution system 106 produces another modified digital image having the generated content portion 506 at a resolution (e.g., a third resolution) that is higher than the initial first resolution and the second resolution generated via the super resolution neural network 518. In some cases, the final resolution is equal to the resolution of the digital image 504.

Though FIG. 5 illustrate the super-resolved digital image 508 as a direct output of the super resolution techniques, it should be understood that the tile-based super resolution system 106 further process the outputs of the super resolution techniques to obtain the super-resolved digital image 508 in some instances. For example, in some cases, the tile-based super resolution system 106 generates the super-resolved digital image 508 by using a mask to composite the output of the employed super resolution technique(s) with the digital image 504. Indeed, in some cases, the tile-based super resolution system 106 uses the super-resolution techniques to process cropped portions of each input and output corresponding cropped portions. Thus, in some cases, to obtain a full image result with a high-resolution generated content portion, the tile-based super resolution system 106 composites a cropped output with the digital image 504.

As mentioned, in one or more embodiments, the tile-based super resolution system 106 uses a super resolution neural network to upscale a generated content portion via a tile-based approach. FIG. 6 illustrates the tile-based super resolution system 106 implementing a tile-based approach to upscaling a generated content portion in accordance with one or more embodiments.

As illustrated in FIG. 6, the tile-based super resolution system 106 implements the tile-based approach using a digital image 602 to be modified (e.g., having a set of pixels to be replaced with a generated content portion) and a modified digital image 604 that includes a modified version of the digital image 602 with the generated content portion. As shown, in some embodiments, the tile-based super resolution system 106 uses a generative neural network 606—such as a diffusion neural network or a generative adversarial network—to generate the modified digital image 604 from the digital image 602.

As further illustrated in FIG. 6, the tile-based super resolution system 106 further implements the tile-based approach using a mask 608 that corresponds to the digital image 602 or the modified digital image 604. For instance, in some cases, the mask 608 includes a mask corresponding to the set of pixels to be replaced or the generated content fill used in generating the modified digital image 604. Indeed, as indicated, the tile-based super resolution system 106 provides the mask 608 to the generative neural network 606 for use in generating the modified digital image 604 in some instances. For example, in some embodiments the tile-based super resolution system 106 uses the mask 608 as a condition or otherwise as an indicator of where the generated content portion is to be inserted. In certain implementations, the mask 608 includes a soft mask.

As shown in FIG. 6, in one or more embodiments, the tile-based super resolution system 106 resizes the inputs to the target resolution of the final image result. As mentioned previously, in some cases, the target resolution includes the resolution of the digital image 602 but include other resolutions in various implementations.

For example, as shown, in certain implementations, the tile-based super resolution system 106 resizes the digital image 602 to create a resized digital image 610. For example, as previously mentioned, in some implementations, the tile-based super resolution system 106 implements the tile-based approach on crops of the inputs. Thus, in some cases, the tile-based super resolution system 106 resizes a crop of the digital image 602 to generate the resized digital image 610. For instance, in some embodiments, the tile-based super resolution system 106 generates the resized digital image 610 using area resampling.

Additionally, as shown, in one or more embodiments, the tile-based super resolution system 106 resizes the modified digital image 604 (e.g., a crop of the modified digital image 604) having the generated content portion to generate a resized modified digital image 612. In some cases, the tile-based super resolution system 106 performs the resizing so that the resized modified digital image 612 includes a blurred modified digital image. For instance, in some embodiments, the tile-based super resolution system 106 uses blurred images in training the super resolution neural network 616 used in implementing the tile-based approach. Thus, in certain instances, the tile-based super resolution system 106 blurs the modified digital image 604 via the resizing to mimic the inputs the super resolution neural network 616 was trained on.

In some implementations, the tile-based super resolution system 106 performs the resizing on the modified digital image 604 based on the determined resolution ratio. To illustrate, in some embodiments, upon determining that the resolution ratio is between an established ratio range (e.g., between a value of 1.0 to 2.0) or below or equal to a threshold ratio (e.g., below or equal to a value of 2.0), the tile-based super resolution system 106 down-samples the modified digital image 604 to create a down-sampled modified digital image. In some cases, the tile-based super resolution system 106 down-samples the modified digital image by a factor determined by dividing the resolution ratio by two. In some instances, the tile-based super resolution system 106 uses area sampling to down-sample the modified digital image 604. In some embodiments, the tile-based super resolution system 106 further up-samples the down-sampled modified digital image to the target resolution to generate the resized modified digital image 612 (e.g., a blurred digital image). In one or more embodiments, the tile-based super resolution system 106 up-samples the down-sampled digital image using bicubic sampling.

In one or more embodiments, upon determining that the resolution ratio is outside the ratio range or above or equal to the threshold ratio (e.g., above or equal to a value of 2.0), the tile-based super resolution system 106 up-samples the modified digital image 604 using bicubic resampling. Indeed, in some instances, using bicubic resampling to generate the resized modified digital image 612 produces a blurred image without the need for previous down-sampling where the resolution ratio is high enough. Thus, in certain instances, the tile-based super resolution system 106 establishes a threshold ratio above which bicubic resampling is sufficient to produce a blurred modified digital image and uses the threshold ratio when generating the resized modified digital image 612.

As further shown in FIG. 6, in one or more embodiments, the tile-based super resolution system 106 resizes the mask 608 (e.g., a crop of the mask 608) to generate a resized mask 614. In some embodiments, the tile-based super resolution system 106 resizes the mask 608 using nearest neighbor resampling. In some implementations, where the mask 608 includes a soft mask, the tile-based super resolution system 106 further thresholds the mask 608 to generate a hard mask. Thus, in some cases, the resized mask 614 includes a resized hard mask.

As illustrated by FIG. 6, the tile-based super resolution system 106 generates input tiles from the input images. In particular, the tile-based super resolution system 106 determines a set of tiles 618a from the digital image 602 (e.g., the resized digital image 610), a set of tiles 618b from the modified digital image 604 (e.g., the resized modified digital image 612), and a set of tiles 618c from the mask 608 (e.g., the resized mask 614). In one or more embodiments, each set of tiles includes a plurality of tiles for the corresponding input image. Further, in some embodiments, each set of tiles includes the same number of tiles with each tile having the same size.

In some cases, each set of tiles includes a set of overlapping tiles. For example, in some cases, each tile in each set of tiles overlaps with at least one other tile in the set. In some instances, the tiles in each set of overlapping tiles is positioned to contain image pixels but omit padding pixels. The configuration of the overlapping tiles will be discussed in more detail with reference to FIGS. 7A-7C. In some cases, the configuration of overlapping tiles is the same for each of the sets of tiles 618a-618c.

As FIG. 6 illustrates, the tile-based super resolution system 106 provides the sets of tiles 618a-618c to the super resolution neural network 616. In some embodiments, the tile-based super resolution system 106 provides the set of tiles 618a-618c in batches. In some cases, the tile-based super resolution system 106 determines the batch size based on memory constraints (e.g., product constraints, user constraints, GPU constraints, or CPU constraints). For instance, in some cases where the tile-based super resolution system 106 operates with a larger memory budge, the tile-based super resolution system 106 provides the set of tiles 618a-618c in larger batches (e.g., batches of two to four tiles each). In contrast, in some cases where the tile-based super resolution system 106 operates with a smaller memory budge, the tile-based super resolution system 106 provides the set of tiles 618a-618c in smaller batches (e.g., one tile per batch). Thus, in some instances, the tile-based super resolution system 106 scales the batch size with the amount of memory that is available.

The tile-based super resolution system 106 uses the super resolution neural network 616 to output another set of tiles 620 based on processing the sets of tiles 618a-618c. In some cases, the set of tiles 620 output by the super resolution neural network 616 includes the same number of tiles having the same configuration of the sets of tiles 618a-618c. Indeed, in some cases, the set of tiles 620 also include overlapping tiles. In some instances, the set of tiles 620 portray the generated content portion from the modified digital image 604 but at a resolution that is higher than the first resolution with which the generated content portion was originally created. In some cases, the set of tiles 620 portray the generated content portion at the target resolution.

In one or more embodiments, the tile-based super resolution system 106 assembles or arranges the set of tiles 620 output by the super resolution neural network 616. For example, in some cases, the tile-based super resolution system 106 assembles the tiles so that they correctly portray the digital content. For instance, in some cases, the tile-based super resolution system 106 tracks the location of each tile used as input to the super resolution neural network 616 and positions the corresponding output tile in the same location.

As shown, the tile-based super resolution system 106 performs blending 622 on the set of tiles 620 output by the super resolution neural network 616. In particular, where the set of tiles 620 include overlapping tiles, the tile-based super resolution system 106 performs the blending 622 on the regions of overlap. The blending of the overlapping tiles will be discussed further with respect to FIGS. 7A-7C. Through the blending 622, the tile-based super resolution system 106 creates an additional modified digital image having the generated content portion at the higher resolution (e.g., the target resolution) than the first resolution.

As further shown in FIG. 6, the tile-based super resolution system 106 also performs compositing 624 on the result from the blending 622. For instance, in some cases, the tile-based super resolution system 106 composites the modified digital image resulting from the blending 622 with the digital image 602. In some embodiments, the tile-based super resolution system 106 performs the compositing 624 using the mask 608 (e.g., the soft mask). Upon compositing the modified digital image from the blending 622 with the digital image 602, the tile-based super resolution system 106 generates a super-resolved digital image 626 having the generated content portion at the target resolution (e.g., the resolution of the digital image 602).

In some instances, such as where the resolution ratio is above (or at least equal to) the high threshold, the tile-based super resolution system 106 up-samples the result of the blending 622. In particular, in some embodiments, the tile-based super resolution system 106 performs bicubic resampling to up-sample the modified digital image resulting from the blending 622. Thus, the tile-based super resolution system 106 generates another modified digital image having the generated content portion that is higher than output by the super resolution neural network 616. In some cases, the tile-based super resolution system 106 performs the compositing 624 using the up-sampled modified digital image resulting from the bicubic resampling to generate the super-resolved digital image 626.

In one or more embodiments, the tile-based super resolution system 106 uses, as the super resolution neural network 616, the generative adversarial network described in U.S. patent application Ser. No. 17/661,985 or U.S. patent application Ser. No. 18/232,212. In some cases, however, the tile-based super resolution system 106 uses another generative model, such as a diffusion neural network or a one-step distilled model (e.g., a GAN-based distillation model).

Further, in some cases, the tile-based super resolution system 106 trains the super resolution neural network 616 to generate output tiles portraying generated content portions at higher resolutions. For instance, in some embodiments, the tile-based super resolution system 106 uses an iterative process in which the super resolution neural network 616 is used to generate predicted output tiles from training input tiles, compare the predictions to ground truths using one or more loss functions, and modify network parameters based on the determined losses. As mentioned, in some instances, the tile-based super resolution system 106 used blurred images as one or more of the training input images. For example, in some cases, the tile-based super resolution system 106 uses blurred modified digital images as training input images. In some instances, the blurred modified digital images used for training include synthetically generated low-resolution images. In some cases, the tile-based super resolution system 106 further uses heuristic down-sampling to obtain the blurred effect.

Further, in some implementations, the tile-based super resolution system 106 trains the super resolution neural network 616 on masks that are entirely white or black indicating the set of pixels to be replaced. Indeed, in some cases, during inference, the super resolution neural network 616 will process tiles that are entirely within the boundaries of the set of pixels to be replaced. Accordingly, in some embodiments, the tile-based super resolution system 106 trains the super resolution neural network 616 using at least some white masks to mimic this scenario.

Additionally, in one or more embodiments, the tile-based super resolution system 106 trains the super resolution neural network 616 on cropped images. For instance, in some cases, the tile-based super resolution system 106 generates crop bounding boxes on the training images and uses the image portions within the bounding boxes for training. In some embodiments, the tile-based super resolution system 106 generates the crop bounding boxes randomly or semi-randomly.

In one or more embodiments, by implementing a tile-based approach to upscaling generated content portions, the tile-based super resolution system 106 operates with improved efficiency when compared to conventional systems. In particular, by processing batches of tiles as small as one tile per patch-rather than processing an entire image at the same time—the tile-based super resolution system 106 reduces the amount of memory required to upscale a generated content portion. Indeed, in some instances, such as when using a batch size of one, the tile-based super resolution system 106 operates on as little memory as required by the super resolution neural network itself. Further, by using adjustable batch sizes, the tile-based super resolution system 106 operates more flexibly than conventional systems. Indeed, one or more embodiments of the tile-based super resolution system 106 scale the batch size used based on memory constraints, enabling flexible deployment on client devices. Further, in some instances, but using the tile-based approach, the tile-based super resolution system 106 obtains higher quality image results where the generated content portion better matches the resolution of the rest of the digital image.

As mentioned, in some implementations, the tile-based super resolution system 106 determines sets of overlapping tiles as input to a super resolution neural network. Further, the tile-based super resolution system 106 uses the super resolution neural network to output a set of overlapping tiles based on the sets of overlapping tiles used as input. FIGS. 7A-7C illustrate the tile-based super resolution system 106 using overlapping tiles in implementing a tile-based approach to upscaling a generated content portion for a digital image in accordance with one or more embodiments.

In particular, FIG. 7A illustrates a set of overlapping tiles corresponding to a digital image 700 (e.g., a digital image, a modified digital image, or a mask) in accordance with one or more embodiments. The set of overlapping tiles includes tiles 702a-702i. Though a particular number of tiles are shown in FIG. 7A, the tile-based super resolution system 106 uses various numbers of tiles in various implementations.

In one or more embodiments, the tile-based super resolution system 106 determines or generates the tiles 702a-702i using a fixed size. Further, in some cases, the tile-based super resolution system 106 establishes a threshold number of pixels by which the tiles overlap. In some embodiments, the tile-based super resolution system 106 uses the threshold number of overlapping pixels in determining how to blend the overlapping tiles generated by the super resolution neural network. The blending of overlapping tiles will be discussed more with respect to FIGS. 7B-7C. In one or more embodiments, causing the tiles to overlap causes the pixels within those regions to overlap. Thus, regions of overlap between two or more tiles includes pixels from each of those tiles. In some cases, an overlapping portion includes an area in which two or more tiles overlap. In some instances, an overlapping portion includes a portion of one tile that overlaps with a portion of another tile. In other words, in some cases, an overlapping portion includes a portion of a tile that is part of an overlap or includes the region in which portions from two or more tiles overlap.

As shown in FIG. 7A, a subset of the tiles 702a-702i overlap with overlapping portions that are equal to the threshold number of overlapping pixels. For example, the tile 702g and the tile 702h overlap with an overlapping portion 704 that is equal to the threshold number of overlapping pixels. As further shown, however, another subset of the tiles 702a-702i overlap with an overlapping portion that extends beyond the threshold number of overlapping pixels. In other words, a subset of the tiles 702a-702i overlap with an overlapping portion that includes overlapping pixels in addition to the threshold number of overlapping pixels. For instance, as illustrated, the tile 702h and the tile 702i overlap with an overlapping portion that includes a first overlapping portion 706a having the threshold number of overlapping pixels and a second overlapping portion 706b having overlapping pixels in addition to the threshold number of overlapping pixels.

Indeed, as indicated by FIG. 7A, in one or more embodiments, the tile-based super resolution system 106 determines or generates the set of overlapping tiles by determining or generating a grid of overlapping tiles positioned within the boundaries of the digital image 700, causing each tile in the set to contain image pixels and omit padding pixels. In particular, in some cases, tile-based super resolution system 106 positions the tiles in the last row and/or the last column of the grid so that those tiles contain only valid image pixels without additional padding. To illustrate, in some cases, having the tiles only overlap by the threshold amount of overlapping pixels causes the tiles in the last row and/or the last column to extend beyond the boundaries of digital image 700. Accordingly, in certain embodiments, the tile-based super resolution system 106 shifts the tiles of the last row and/or the last column to be positioned completely within the boundaries of the digital image 700.

As further shown in FIG. 7A, some overlapping portions, such as the overlapping portion 704 correspond to an overlap between two tiles. Additionally, some overlapping portions, such as the overlapping portion 708, correspond to an overlap between four tiles. For instance, the overlapping portion 708 corresponds to an overlap between the tile 702d, the tile 702e, the tile 702g, and the tile 702h. In one or more embodiments, when assembling overlapping tiles generated by the super resolution neural network, the tile-based super resolution system 106 blends these overlapping portions. In some cases, the tile-based super resolution system 106 uses a blending method determined based on how many tiles are overlapping in that overlapping portion.

For clarity, FIG. 7B illustrates a subset of the tiles from FIG. 7A that includes the tile 702a, the tile 702b, the tile 702d, and the tile 702e. As shown, an overlapping portion 710a corresponds an overlap between the tile 702a and the tile 702b. Likewise, an overlapping portion 710b corresponds to an overlap between the tile 702a and the tile 702d. As shown in FIG. 7B, the tile-based super resolution system 106 uses linear blending 712 to blend these overlap portions. In particular, the tile-based super resolution system 106 linearly blends the tiles in each overlap portion based on the distance to the boundary of the overlap portion. To illustrate, in some implementations, the tile-based super resolution system 106 linearly blends an overlapping portion by weighing pixels in the center of the overlapping portion the same and changing the weights towards the boundaries of the overlapping portion so that pixels of the tile closer to the boundary have a higher weight. In some cases, the tile-based super resolution system 106 linearly blends the overlapping portion 710a so that the weights change for the overlapping pixels included therein with respect to an x-axis. Similarly, in some instances, the tile-based super resolution system 106 linearly blends the overlapping portion 710b so that the weights change for the overlapping pixels included therein with respect to the y-axis.

As further shown in FIG. 7B, an overlapping portion 714 corresponds to an overlap between the tile 702a, the tile 702b, the tile 702d, and the tile 702e. As indicated, the tile-based super resolution system 106 uses bilinear blending 716 to blend the overlapping portion 714. For instance, in some cases, the tile-based super resolution system 106 blends the overlapping portion 714 using linear blending with respect to the x-axis and also using linear blending with respect to the y-axis. As such, in some embodiments, the tile-based super resolution system 106 blends the overlapping portion by weighing the pixels included therein based on their distance to the corners of the overlapping portion 714.

FIG. 7C illustrates another subset of the tiles from FIG. 7A including the tile 702b, the tile 702c, the tile 702e, and the tile 702f. In addition to showing overlapping portions in which the tile-based super resolution system 106 uses the linear blending 712 and the bilinear blending 716, FIG. 7C shows an overlapping portion in which the tile-based super resolution system 106 uses no blending 718. Indeed, FIG. 7C shows a first overlapping portion 720 between the tile 702b and the tile 702c that includes the threshold number of overlapping pixels. FIG. 7C further shows a second overlapping portion 722 between the tile 702b and the tile 702c that includes overlapping pixels in addition to the threshold number of overlapping pixels. Thus, as indicated, the tile-based super resolution system 106 blends the first overlapping portion 720 without blending the second overlapping portion 722. In some cases, the tile-based super resolution system 106 uses the pixels from the tile 702b that are within the second overlapping portion 722 in the modified digital image that results from combining the tiles 702a-702i. In some instances, however, the tile-based super resolution system 106 uses the pixels from the tile 702c that are within the second overlapping portion 722.

In one or more embodiments, the tile-based super resolution system 106 sets the threshold number of overlap pixels to zero. Thus, in some cases, the tile-based super resolution system 106 does not use any blending even where tiles overlap (e.g., when shifting the last row and/or last column of tiles to cause those tiles to be positioned within the boundaries of the digital image). Rather, the tile-based super resolution system 106 selects pixels from one of the tiles that are part of the overlap to include in the resulting modified digital image.

Turning now to FIG. 8, additional detail will now be provided regarding various components and capabilities of the tile-based super resolution system 106. In particular, FIG. 8 illustrates the tile-based super resolution system 106 implemented by the computing device 800 (e.g., the server(s) 102 and/or one of the client devices 110a-110n discussed above with reference to FIG. 1). Additionally, the tile-based super resolution system 106 is also part of the image editing system 104. As shown, in one or more embodiments, the tile-based super resolution system 106 includes, but is not limited to, a content generation engine 802, a resizing engine 804, a tile generator 806, a super resolution engine 808, a blending manager 810, and data storage 812 (which includes a generative neural network 814 and a super resolution neural network 816).

As just mentioned, and as illustrated in FIG. 8, the tile-based super resolution system 106 includes the content generation engine 802. In one or more embodiments, the content generation engine 802 generates generated content portions for inclusion within a digital image. In particular, in some cases, the content generation engine 802 generates, from a digital image, a modified digital image having a generated content portion that replaces a set of pixels from the digital image. In some embodiments, the content generation engine 802 uses an AI-based model, such as a generative neural network, to generate the modified digital image.

Additionally, as shown in FIG. 8, the tile-based super resolution system 106 includes the resizing engine 804. In one or more embodiments, the resizing engine 804 resizes images that will be input to a super resolution neural network for upscaling a generated content portion. For instance, in some cases, the resizing engine 804 uses one or more up-sampling and/or down-sampling techniques to resize the image input.

Further, as shown in FIG. 8, the tile-based super resolution system 106 includes the tile generator 806. In one or more embodiments, the tile generator 806 generates tiles from the images that are to be input to the super resolution neural network. For instance, in some cases, the tile generator 806 generates a set of overlapping tiles from each image input. In some instances, the tile generator 806 generates the set of overlapping tiles so that each included tile includes image pixels but omits padding pixels.

As shown in FIG. 8, the tile-based super resolution system 106 also includes the super resolution engine 808. In one or more embodiments, the super resolution engine 808 upscales a generated content portion incorporated within a digital image. For instance, in some embodiments, the super resolution engine 808 uses a super resolution neural network and/or bicubic resampling to upscale the generated content portion. In some implementations, the super resolution engine 808 uses a low threshold and/or a high threshold in determining which super resolution technique(s) to apply.

As further shown in FIG. 8, the tile-based super resolution system 106 includes the blending manager 810. In one or more embodiments, the blending manager 810 blends tiles output by a super resolution neural network. In particular, in some embodiments, the blending manager 810 blends the overlapping portions of the tiles. For instance, in certain embodiments, the blending manager 810 employs linear blending to blend regions where two tiles overlap and bilinear blending to blend regions where four tiles overlap. In some cases, the blending manager 810 further identifies regions of overlap in which no blending is applied.

As shown in FIG. 8, the tile-based super resolution system 106 further includes data storage 812. In particular, data storage 812 includes the generative neural network 814 and the super resolution neural network 816.

Each of the components 802-816 of the tile-based super resolution system 106 optionally include software, hardware, or both. For example, in some cases, the components 802-816 include one or more instructions stored on a computer-readable storage medium and executable by processors of one or more computing devices, such as a client device or server device. When executed by the one or more processors, the computer-executable instructions of the tile-based super resolution system 106 cause the computing device(s) to perform the methods described herein. Alternatively, in some embodiments, the components 802-816 include hardware, such as a special-purpose processing device to perform a certain function or group of functions. Alternatively, in certain implementations, the components 802-816 of the tile-based super resolution system 106 include a combination of computer-executable instructions and hardware.

Furthermore, in one or more embodiments, the components 802-816 of the tile-based super resolution system 106 are, for example, implemented as one or more operating systems, as one or more stand-alone applications, as one or more modules of an application, as one or more plug-ins, as one or more library functions or functions that are called by other applications, and/or as a cloud-computing model. Thus, in some embodiments, the components 802-816 of the tile-based super resolution system 106 are implemented as a stand-alone application, such as a desktop or mobile application. Furthermore, in some cases, the components 802-816 of the tile-based super resolution system 106 are implemented as one or more web-based applications hosted on a remote server. Alternatively, or additionally, the components 802-816 of the tile-based super resolution system 106 are implemented in a suite of mobile device applications or “apps.” For example, in one or more embodiments, the tile-based super resolution system 106 comprises or operates in connection with digital software applications such as ADOBE® PHOTOSHOP® or ADOBE® LIGHTROOM®. The foregoing are either registered trademarks or trademarks of Adobe Inc. in the United States and/or other countries.

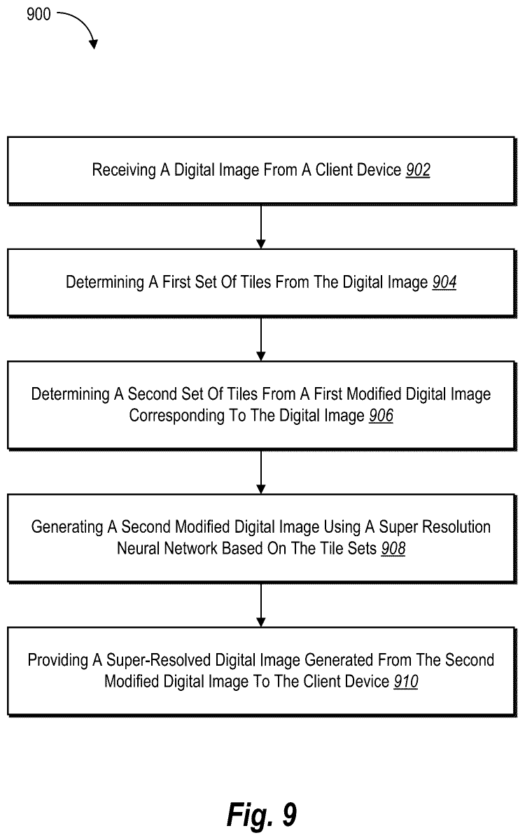

FIGS. 1-8, the corresponding text, and the examples provide a number of different methods, systems, devices, and non-transitory computer-readable media of the tile-based super resolution system 106. In addition to the foregoing, one or more embodiments can also be described in terms of flowcharts comprising acts for accomplishing the particular result, as shown in FIG. 9. In certain embodiments, process illustrated in FIG. 9 is performed with more or fewer acts. Further, in some implementations, the acts are performed in different orders. Additionally, in some instances, the acts described herein are repeated or performed in parallel with one another or in parallel with different instances of the same or similar acts.

FIG. 9 illustrates a flowchart of a series of acts 900 for upscaling a generated content portion incorporated into a digital image in accordance with one or more embodiments. While FIG. 9 illustrates acts according to one or more embodiments, certain embodiments omit, add to, reorder, and/or modify any of the acts shown in FIG. 9. In some implementations, the acts of FIG. 9 are performed as part of a computer-implemented method. Alternatively, a non-transitory computer-readable medium stores executable instructions thereon that, when executed by at least one processor, cause the at least one processor to perform operations comprising the acts of FIG. 9. In some embodiments, a system performs the acts of FIG. 9. For example, in one or more embodiments, a system includes one or more memory devices. The system further includes one or more processors that are coupled to the one or more memory devices and configured to cause the system to perform the acts of FIG. 9.

The series of acts 900 includes an act 902 for receiving a digital image from a client device. For example, in one or more embodiments, the act 902 involves receiving, from a client device, a digital image having a set of pixels to be replaced with a generated content portion.

The series of acts 900 also includes an act 904 for determining a first set of tiles from the digital image. In some cases, the act 904 involves determining a first set of overlapping tiles from the digital image. For example, in some instances, determining the first set of tiles from the digital image comprises determining, from the digital image, a first set of overlapping tiles having pairs of tiles that overlap with at least a threshold number of overlapping pixels. In certain implementations, determining the first set of overlapping tiles comprises generating a grid of overlapping tiles positioned within boundaries of the digital image, causing each tile in the first set of overlapping tiles to contain image pixels and omit padding pixels.

Additionally, the series of acts 900 includes an act 906 for determining a second set of tiles from a first modified digital image corresponding to the digital image. For instance, in some embodiments, the act 906 involves determining a second set of tiles from a first modified digital image that corresponds to the digital image and includes the generated content portion at a first resolution. In some embodiments, the act 906 involves determining a second set of overlapping tiles from the first modified digital image. For example, in some instances, determining the second set of tiles from the first modified digital image comprises determining, from the first modified digital image, a second set of overlapping tiles having additional pairs of tiles that overlap with at least the threshold number of overlapping pixels.

The series of acts 900 further includes an act 908 for generating a second modified digital image using a super resolution neural network based on the tile sets. To illustrate, in some instances, the act 908 involves generating, using a super resolution neural network and based on the first set of tiles and the second set of tiles, a second modified digital image that corresponds to the digital image and includes the generated content portion at a second resolution that is higher than the first resolution. In certain embodiments, generating the second modified digital image using the super resolution neural network comprises generating the second modified digital image using a cascaded modulated generative adversarial network.

In some embodiments, generating, using the super resolution neural network and based on the first set of tiles and the second set of tiles, the second modified digital image comprises: generating, using the super resolution neural network and based on the first set of overlapping tiles and the second set of overlapping tiles, a third set of overlapping tiles having further pairs of tiles that overlap with at least the threshold number of overlapping pixels; and generating the second modified digital image by blending overlapping portions within the third set of overlapping tiles. In some cases, generating the second modified digital image by blending the overlapping portions within the third set of overlapping tiles comprises: determining, for a pair of tiles, a first overlapping portion that includes the threshold number of overlapping pixels; determining, for the pair of tiles, a second overlapping portion that includes overlapping pixels in addition to the threshold number of overlapping pixels; and generating the second modified digital image by blending the first overlapping portion without blending the second overlapping portion.

In one or more embodiments, the tile-based super resolution system 106 further determines a resolution ratio based on a third resolution of the digital image and the first resolution of the generated content portion from the first modified digital image; and determines that the resolution ratio is above a low threshold. Thus, in some cases, generating the second modified digital image using the super resolution neural network comprises using the super resolution neural network to generate the second modified digital image based on determining that the resolution ratio is above the low threshold.

In some cases, the tile-based super resolution system 106 further determines a third set of tiles from a soft mask that corresponds to the digital image. As such, in some instances, generating the second modified digital image based on the first set of tiles and the second set of tiles comprises generating the second modified digital image based on the first set of tiles, the second set of tiles, and the third set of tiles.

Further, the series of acts 900 includes an act 910 for providing a super-resolved digital image generated from the second modified digital image to the client device. In particular, in some embodiments, the act 910 involves providing a super-resolved digital image generated from the second modified digital image for display on the client device.

In some embodiments, the tile-based super resolution system 106 further determines a resolution ratio based on a third resolution of the digital image and the first resolution of the generated content portion from the first modified digital image; determines that the resolution ratio is above a high threshold; and up-samples, using bicubic resampling, the second modified digital image to generate a third modified digital image that corresponds to the digital image and includes the generated content portion at the third resolution of the digital image, wherein the third resolution is higher than the second resolution. Accordingly, in some instances, providing the super-resolved digital image generated from the second modified digital image for display on the client device comprises providing the super-resolved digital image generated from the third modified digital image for display on the client device.

To provide an illustration, in one or more embodiments, the tile-based super resolution system 106 determines, from a digital image having a set of pixels to be replaced with a generated content portion, a first set of overlapping tiles; determines, from a first modified digital image that corresponds to the digital image and includes the generated content portion at a first resolution, a second set of overlapping tiles; generates, using a super resolution neural network, a third set of overlapping tiles based on the first set of overlapping tiles and the second set of overlapping tiles; and generates, from the third set of overlapping tiles, a second modified digital image that corresponds to the digital image and includes the generated content portion at a second resolution that is higher than the first resolution.

In some embodiments, generating the second modified digital image from the third set of overlapping tiles comprises: determining, from the third set of overlapping tiles, one or more overlapping portions where two tiles overlap with at least a threshold number of overlapping pixels; and generating the second modified digital image by blending the one or more overlapping portions using linear blending. Additionally, in some instances, determining the one or more overlapping portions where two tiles overlap with at least a threshold number of overlapping portions comprises determining, for a pair of tiles, a first overlapping portion that includes the threshold number of overlapping pixels and a second overlapping portion that includes overlapping pixels in addition to the threshold number of overlapping pixels; and generating the second modified digital image by blending the one or more overlapping portions using the linear blending comprises generating the second modified digital image by blending the first overlapping portion using the linear blending without blending the second overlapping portion.

In some implementations, generating the second modified digital image from the third set of overlapping tiles comprises: determining, from the third set of overlapping tiles, one or more overlapping portions where four tiles overlap; and generating the second modified digital image by blending the one or more overlapping portions using bilinear blending.

Additionally, in certain embodiments, the tile-based super resolution system 106 further generates, using a generative neural network and from the digital image, the first modified digital image having the generated content portion at the first resolution, wherein the first resolution of the generated content portion is lower than a resolution of the digital image. In some instances, generating the first modified digital image using the generative neural network comprises generating the first modified digital image using a diffusion neural network; and generating the third set of overlapping tiles using the super resolution neural network comprises generating the third set of overlapping tiles using a cascaded modulated generative adversarial network.

To provide another illustration, in some embodiments, the tile-based super resolution system 106 determines a first set of tiles from a digital image having a set of pixels to be replaced with a generated content portion; determines a second set of tiles from a first modified digital image that corresponds to the digital image and includes the generated content portion at a first resolution; and generates, using a super resolution neural network and based on the first set of tiles and the second set of tiles, a second modified digital image that corresponds to the digital image and includes the generated content portion at a second resolution that is higher than the first resolution.

In some instances, the tile-based super resolution system 106 further generates a super-resolved digital image by compositing the second modified digital image with the digital image having the set of pixels to be replaced with the generated content portion. In some embodiments, compositing the second modified digital image with the digital image comprises compositing the second modified digital image with the digital image using a soft mask that corresponds to the digital image.

In some cases, the tile-based super resolution system 106 further generates a blurred modified digital image by: down-sampling the first modified digital image using area sampling to generate a down-sampled modified digital image; and up-sampling the down-sampled modified digital image using bicubic sampling. Thus, in some instances, determining the second set of tiles from the first modified digital image comprises determining the second set of tiles from the blurred modified digital image. Additionally, in certain embodiments, the tile-based super resolution system 106 further determines a resolution ratio based on a third resolution of the digital image and the first resolution of the generated content portion from the first modified digital image. As such, in some cases, generating the blurred modified digital image comprises generating the blurred modified digital image based on determining that the resolution ratio is within an established range of resolution ratios.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates a block diagram of an example computing device 1000 that is configurable to perform one or more of the processes described above. One will appreciate that one or more computing devices, such as the computing device 1000 represent the computing devices described above (e.g., the server(s) 102 and/or the client devices 110a-110n) in certain embodiments. In one or more embodiments, the computing device 1000 includes a mobile device (e.g., a mobile telephone, a smartphone, a PDA, a tablet, a laptop, a camera, a tracker, a watch, a wearable device). In some embodiments, the computing device 1000 includes a non-mobile device (e.g., a desktop computer or another type of client device). Further, in some instances, the computing device 1000 includes a server device that includes cloud-based processing and storage capabilities.

As shown in FIG. 10, the computing device 1000 includes one or more processor(s) 1002, memory 1004, a storage device 1006, input/output interfaces 1008 (or “I/O interfaces 1008”), and a communication interface 1010, which are communicatively coupled by way of a communication infrastructure (e.g., bus 1012). While the computing device 1000 is shown in FIG. 10, the components illustrated in FIG. 10 are not intended to be limiting. Additional or alternative components are used in certain embodiments. Furthermore, in certain embodiments, the computing device 1000 includes fewer components than those shown in FIG. 10. Components of the computing device 1000 shown in FIG. 10 will now be described in additional detail.

In particular embodiments, the processor(s) 1002 includes hardware for executing instructions, such as those making up a computer program. As an example, and not by way of limitation, to execute instructions, the processor(s) 1002 retrieve (or fetch) the instructions from an internal register, an internal cache, memory 1004, or a storage device 1006 and decode and execute them.

The computing device 1000 includes memory 1004, which is coupled to the processor(s) 1002. The memory 1004 is used for storing data, metadata, and programs for execution by the processor(s). The memory 1004 includes one or more of volatile and non-volatile memories, such as Random-Access Memory (“RAM”), Read-Only Memory (“ROM”), a solid-state disk (“SSD”), Flash, Phase Change Memory (“PCM”), or other types of data storage. In some cases, the memory 1004 includes internal or distributed memory.

The computing device 1000 includes a storage device 1006 including storage for storing data or instructions. As an example, and not by way of limitation, the storage device 1006 can include a non-transitory storage medium described above. In some embodiments, the storage device 1006 includes a hard disk drive (HDD), flash memory, a Universal Serial Bus (USB) drive or a combination of these or other storage devices.

As shown, the computing device 1000 includes one or more I/O interfaces 1008, which are provided to allow a user to provide input to (such as user strokes), receive output from, and otherwise transfer data to and from the computing device 1000. In some implementations, these I/O interfaces 1008 include a mouse, keypad or a keyboard, a touch screen, camera, optical scanner, network interface, modem, other known I/O devices or a combination of such I/O interfaces 1008. In some instances, the touch screen is activated with a stylus or a finger.

In some instances, the I/O interfaces 1008 include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1008 are configured to provide graphical data to a display for presentation to a user. In some implementations, the graphical data is representative of one or more graphical user interfaces and/or any other graphical content that serves a particular implementation.

The computing device 1000 can further include a communication interface 1010. The communication interface 1010 can include hardware, software, or both. The communication interface 1010 provides one or more interfaces for communication (such as, for example, packet-based communication) between the computing device and one or more other computing devices or one or more networks. As an example, and not by way of limitation, in some cases, communication interface 1010 includes a network interface controller (NIC) or network adapter for communicating with an Ethernet or other wire-based network or a wireless NIC (WNIC) or wireless adapter for communicating with a wireless network, such as a WI-FI. The computing device 1000 can further include a bus 1012. The bus 1012 can include hardware, software, or both that connects components of computing device 1000 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

In certain implementations, the present invention is embodied in other specific forms without departing from its spirit or essential characteristics. The described embodiments are to be considered in all respects only as illustrative and not restrictive. For example, in some instances, the methods described herein are performed with less or more steps/acts or the steps/acts are performed in differing orders. Additionally, in some embodiments, the steps/acts described herein are repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving, from a client device, a digital image having a set of pixels to be replaced with a generated content portion;
determining a first set of tiles from the digital image;
determining a second set of tiles from a first modified digital image that corresponds to the digital image and includes the generated content portion at a first resolution;
generating, using a super resolution neural network and based on the first set of tiles and the second set of tiles, a second modified digital image that corresponds to the digital image and includes the generated content portion at a second resolution that is higher than the first resolution; and
providing a super-resolved digital image generated from the second modified digital image for display on the client device.

2. The computer-implemented method of claim 1, further comprising:
determining a resolution ratio based on a third resolution of the digital image and the first resolution of the generated content portion from the first modified digital image; and
determining that the resolution ratio is above a low threshold,
wherein generating the second modified digital image using the super resolution neural network comprises using the super resolution neural network to generate the second modified digital image based on determining that the resolution ratio is above the low threshold.

3. The computer-implemented method of claim 1, further comprising:
determining a resolution ratio based on a third resolution of the digital image and the first resolution of the generated content portion from the first modified digital image;
determining that the resolution ratio is above a high threshold; and
up-sampling the second modified digital image to generate a third modified digital image that corresponds to the digital image and includes the generated content portion at the third resolution of the digital image, wherein the third resolution is higher than the second resolution,
wherein providing the super-resolved digital image generated from the second modified digital image for display on the client device comprises providing the super-resolved digital image generated from the third modified digital image for display on the client device.

4. The computer-implemented method of claim 1, wherein generating the second modified digital image using the super resolution neural network comprises generating the second modified digital image using a generative adversarial network.

5. The computer-implemented method of claim 1, wherein:
determining the first set of tiles from the digital image comprises determining, from the digital image, a first set of overlapping tiles having pairs of tiles that overlap with at least a threshold number of overlapping pixels; and
determining the second set of tiles from the first modified digital image comprises determining, from the first modified digital image, a second set of overlapping tiles having additional pairs of tiles that overlap with at least the threshold number of overlapping pixels.

6. The computer-implemented method of claim 5, wherein determining the first set of overlapping tiles comprises generating a grid of overlapping tiles positioned within boundaries of the digital image, causing each tile in the first set of overlapping tiles to contain image pixels and omit padding pixels.

7. The computer-implemented method of claim 5, wherein generating, using the super resolution neural network and based on the first set of tiles and the second set of tiles, the second modified digital image comprises:
generating, using the super resolution neural network and based on the first set of overlapping tiles and the second set of overlapping tiles, a third set of overlapping tiles having further pairs of tiles that overlap with at least the threshold number of overlapping pixels; and
generating the second modified digital image by blending overlapping portions within the third set of overlapping tiles.

8. The computer-implemented method of claim 7, wherein generating the second modified digital image by blending the overlapping portions within the third set of overlapping tiles comprises:
determining, for a pair of tiles, a first overlapping portion that includes the threshold number of overlapping pixels;
determining, for the pair of tiles, a second overlapping portion that includes overlapping pixels in addition to the threshold number of overlapping pixels; and
generating the second modified digital image by blending the first overlapping portion without blending the second overlapping portion.

9. The computer-implemented method of claim 1,
further comprising determining a third set of tiles from a soft or hard mask that corresponds to the digital image,
wherein generating the second modified digital image based on the first set of tiles and the second set of tiles comprises generating the second modified digital image based on the first set of tiles, the second set of tiles, and the third set of tiles.

10. A system comprising:
one or more memory devices; and
one or more processors coupled to the one or more memory devices that cause the system to perform operations comprising:
determining, from a digital image having a set of pixels to be replaced with a generated content portion, a first set of overlapping tiles;
determining, from a first modified digital image that corresponds to the digital image and includes the generated content portion at a first resolution, a second set of overlapping tiles;
generating, using a super resolution neural network, a third set of overlapping tiles based on the first set of overlapping tiles and the second set of overlapping tiles; and
generating, from the third set of overlapping tiles, a second modified digital image that corresponds to the digital image and includes the generated content portion at a second resolution that is higher than the first resolution.

11. The system of claim 10, wherein generating the second modified digital image from the third set of overlapping tiles comprises:
determining, from the third set of overlapping tiles, one or more overlapping portions where two tiles overlap with at least a threshold number of overlapping pixels; and
generating the second modified digital image by blending the one or more overlapping portions.

12. The system of claim 11, wherein:
determining the one or more overlapping portions where two tiles overlap with at least a threshold number of overlapping portions comprises determining, for a pair of tiles, a first overlapping portion that includes the threshold number of overlapping pixels and a second overlapping portion that includes overlapping pixels in addition to the threshold number of overlapping pixels; and
generating the second modified digital image by blending the one or more overlapping portions comprises generating the second modified digital image by blending the first overlapping portion without blending the second overlapping portion.

13. The system of claim 10, wherein generating the second modified digital image from the third set of overlapping tiles comprises:
determining, from the third set of overlapping tiles, one or more overlapping portions where four tiles overlap; and
generating the second modified digital image by blending the one or more overlapping portions using bilinear blending.

14. The system of claim 10, wherein the operations further comprise generating, using a generative neural network and from the digital image, the first modified digital image having the generated content portion at the first resolution, wherein the first resolution of the generated content portion is lower than a resolution of the digital image.

15. The system of claim 14, wherein:
generating the first modified digital image using the generative neural network comprises generating the first modified digital image using a diffusion neural network; and
generating the third set of overlapping tiles using the super resolution neural network comprises generating the third set of overlapping tiles using a generative adversarial network.

16. A non-transitory computer-readable medium storing instructions thereon that, when executed by at least one processor, cause the at least one processor to perform operations comprising:
determining a first set of tiles from a digital image having a set of pixels to be replaced with a generated content portion;
determining a second set of tiles from a first modified digital image that corresponds to the digital image and includes the generated content portion at a first resolution; and
generating, using a super resolution neural network and based on the first set of tiles and the second set of tiles, a second modified digital image that corresponds to the digital image and includes the generated content portion at a second resolution that is higher than the first resolution.

17. The non-transitory computer-readable medium of claim 16, wherein the operations further comprise generating a super-resolved digital image by compositing the second modified digital image with the digital image having the set of pixels to be replaced with the generated content portion.

18. The non-transitory computer-readable medium of claim 17, wherein compositing the second modified digital image with the digital image comprises compositing the second modified digital image with the digital image using a mask that corresponds to the digital image.

19. The non-transitory computer-readable medium of claim 16, wherein:
the operations further comprise generating a blurred modified digital image by:
down-sampling the first modified digital image to generate a down-sampled modified digital image; and
up-sampling the down-sampled modified digital image; and
determining the second set of tiles from the first modified digital image comprises determining the second set of tiles from the blurred modified digital image.

20. The non-transitory computer-readable medium of claim 19, wherein:
the operations further comprise determining a resolution ratio based on a third resolution of the digital image and the first resolution of the generated content portion from the first modified digital image; and
generating the blurred modified digital image comprises generating the blurred modified digital image based on determining that the resolution ratio is within an established range of resolution ratios.
